(19) United States
(12) Patent Application Publication
(10) Pub. No.: US 2014/0346222 A1
(43) Pub. Date: Nov. 27, 2014

(54) SYSTEM AND METHOD FOR MANAGEMENT OF COLLECTED FIELD SAMPLES

(71) Applicant: Justin P. MASTYKARZ, Hillsborough, NJ (US)

(72) Inventor: Justin P. MASTYKARZ, Hillsborough, NJ (US)

(21) Appl. No.: 13/840,331

(22) Filed: Mar. 15, 2013

Related U.S. Application Data
(63) Continuation-in-part of application No. 12/980,876, filed on Dec. 29, 2010.

(51) Int. Cl. G06F 17/24; G06F 21/60; G06F 21/31; G06K 19/06

(52) U.S. Cl. CPC G06F 17/243; G06K 19/06037; G06F 21/602; G06F 21/31
USPC 235/375; 715/224; 235/494; 713/189

(57) ABSTRACT

Systems and methods for generating, by an electronic circuit of a mobile device, a form for display on the mobile device for a user to input sample collection data are provided. The form includes one or more data input fields, and the electronic circuit performs the steps of accepting input of data regarding sample collection to the one or more data input fields by a user from an input control of the mobile device, and sending input data information to a server in communication with the mobile device. Additionally, a pre-existing or new form definition file containing a template describing the information to be displayed on the form and characteristics of one or more data input field of the form may be accessed or generated, and displayed onto the display. Management of forms, reports, and form definition files are also provided for, including uploading to a server.

### CROSS REFERENCE TO RELATED APPLICATIONS

This application is a continuation-in-part of, and claims priority from co-pending U.S. patent application Ser. No. 12/980,876, filed on Dec. 29, 2010, entitled “Methods and Apparatus for Management of Field Operations, Projects and/or Collected Samples”, by Justin P. Mastykarz, which claims priority from U.S. Provisional Patent Application Ser. No. 61/290,806 filed Dec. 29, 2009. These applications are also incorporated herein by reference in their entirety.

### FIELD OF THE INVENTION

The present application is directed to methods and apparatus for managing field operations, projects, collection and identification of samples and generation of reports.

### BACKGROUND OF THE INVENTION

Testing of sites, e.g., for chemical contamination, is used in a wide range of applications including environmental consulting, criminal justice, civil litigation, etc.

Often testing results come into question with inquiries being made as to whether a collected sample actually corresponds to a particular site or location and/or whether the test results are reliable.

In view of the above, it should be appreciated that there is a need for improving techniques, automation and methodologies of sample collection, documentation generation of and access to test reports, as well as establishing a chain of custody and that a particular sample corresponds to a particular site.

There is also a need for a user to be able to ensure collection and reporting of all the information pertaining to a given sample and, or sample collection site and/or other relevant field audit data required to efficiently process a sample and generate one or more report(s) regarding the sample. There is also a need for the user to have the ability to customize sample information collection, report generation and access to sample data and reports.

### SUMMARY OF THE INVENTION

Methods, systems and apparatus for collecting and identifying samples, and for associating sample information with test results, are described. Methods, systems and apparatus for associating sample information and test results, which can be accessed electronically, are also described.

The methods, systems and apparatus of the present invention are particular well suited for use in testing and reporting applications. In accordance with one exemplary embodiment, information corresponding to a project. e.g. a site testing project, are entered in to a database, which is part of a record keeping and report generation system. The record keeping and report generation system may be located at a testing facility where samples. e.g. soil, water or other types of samples, are taken for processing after collection from the site to be tested.

The methods, systems and apparatus of the present invention can be used to simplify record keeping maintaining a chain of custody (CoC) and facilitate report generation and access to reports.

In accordance with various embodiments, after information relating to a project is entered into the Record Keeping and Report Generation (RKRG) system, an engineer or another individual, hereinafter, “tester”, is sent to a site to be tested for collection of samples. The information entered into the RKRG system may include information including a project identifier, e.g. project number, information about the sites to be tested, e.g. geographic location such as site address, the type and number of samples to be taken from each site or particular portion of a site, information identify the party ordering the report, information identifying the individuals performing sample collection, information identifying the individuals, employees and/or customer's to be allowed remote access to the sample and report information as well as other information such as the encryption method and/or passwords to be used by one or more individuals or customers when accessing the RKRG or information/reports which are generated by the system. Importantly, the RKRG system may also provide information to the tester.

In an aspect of the invention, systems, methods and apparatus are provided for generating, by an electronic circuit of a mobile device, a form for display on the mobile device for a user to input sample collection data are provided. The form includes one or more data input fields, and the electronic circuit performs the steps of accepting input of data regarding sample collection to the one or more data input fields by a user from an input control of the mobile device, and sending input data information to a server in communication with the mobile device. Additionally, a pre-existing or new form definition file containing a template describing the information to be displayed on the form and characteristics of one or more data input field of the form may be accessed or generated, and displayed onto the display. Management of forms, reports, and form definition files are also provided for, including uploading to a server.

Multiple samples and field information may be collected form one or more sites in the above described manner with pictures, e.g., digital watermarked photos, of the test sites and sample containers being sent back to the RKRG system.

Information about the person who collected the sample and field information and one or more individuals who were responsible for the testing of the collected sample are entered into the RKRG system. Thus, for each sample, which is collected and tested, the RKRG maintains information providing a complete chain of custody. Samples are tested and the test results are also stored in the RKRG system.

Reports corresponding to the tested collected samples, field information and the site may be accessed remotely via one or more wireless or wired communications devices, which can connect to the RKRG system, e.g., via the Internet. For security reasons, communications, including the electronic communication of watermarked pictures, test results, etc. may and in some embodiments are, encrypted with the RKRG system decrypting encrypted information and images it receives and user devices decrypting encrypted information received from the RKRG system. Access to reports may be limited to authorized persons or entities enabled to decrypt the information.

Customizable forms may be used to configure the format of reports, and/or for inputting search keys and search criteria. It is envisioned that customizable forms may be used in order to facilitate enforcement of company or governmental standards for required information in both reports and collection of sampling data.

The methods, systems and apparatus of the present invention are particularly well suited for environmental testing and evidence collecting for criminal and civil legal cases, and/or other applications where samples and/or other data are collected, tested, maintained and provided in a secure and/or confidential manner. In addition, the methods, systems and apparatus of the present invention facilitate maintaining a detailed record of the sample collection, field and audit information, and testing processes as well as a chain of sample custody. Thus, not only is reliability and the trustworthiness of the test results increased as compared to some other systems, but the results are particularly well suited for court use where the chain of custody may need to be established, and it may be important that the sample and field and audit information is the sample and record which was actually collected at a particular site.

Numerous additional features, benefits and embodiments are described in the detailed description.

### BRIEF DESCRIPTION OF THE DRAWINGS

FIG. 1 illustrates an exemplary system implemented in accordance with one aspect of the invention.

FIG. 2 illustrates an exemplary web based management server implemented in accordance with one exemplary embodiment.

FIG. 3 illustrates an exemplary client device in accordance with one embodiment of the invention.

FIG. 4 illustrates a picture of a portion of an exemplary site from which an exemplary sample is collected in accordance with one embodiment of the invention.

FIG. 5 illustrates a picture of a container including an exemplary sample collected from a site, in accordance with one embodiment of the invention.

FIG. 6 illustrates a watermarked version of the picture shown in FIG. 5, in accordance with one embodiment of the invention.

FIG. 7 illustrates a watermarked version of the picture of the container including a sample shown in FIG. 6, in accordance with one embodiment of the invention.

FIG. 8 illustrates an exemplary mobile device, e.g., a mobile communications device, in accordance with one embodiment of the invention.

FIG. 9a is an flowchart for an exemplary method that is useful for understanding the present invention.

FIG. 9b is an flowchart for an exemplary method that is useful for understanding the present invention.

FIG. 9c is an flowchart for an exemplary method that is useful for understanding the present invention.

FIG. 10a is a schematic diagram for an exemplary system that is useful for understanding the present invention.

FIG. 10b is a schematic diagram for an exemplary system that is useful for understanding the present invention.

FIG. 11 is a screenshot of an exemplary user interface that is useful for understanding the present invention.

FIG. 12 is a screenshot of an exemplary user interface that is useful for understanding the present invention.

FIG. 13 is a screenshot of an exemplary user interlace that is useful for understanding the present invention.

FIG. 14 is a screenshot of an exemplary user interface that is useful for understanding the present invention.

FIG. 15 is a screenshot of an exemplary user interface that is useful for understanding the present invention

### DETAILED DESCRIPTION

The present invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if. X employs A; X employs B; or X employs both A and B, then “X employs A or B” is satisfied under any of the foregoing instances.

The term “sample collection” is meant to include collection of samples and any other relevant field and audit information such as but not limited to physical samples, photo, position info, audit info, etc.

The present invention advantageously provides systems, methods and apparatus for improving techniques automation and methodologies of sample field and/or audit/survey information collection, documentation generation of and access to test reports, as well as establishing a chain of custody and that a particular sample corresponds to a particular site.

The present invention also advantageously provides for a user to be able to ensure collection and reporting of all the information pertaining to a given sample, field information and related activity, and/or sample collection site as required is obtained and to efficiently process a sample and field information and generate one or more report(s) regarding the sample.

The present invention also advantageously provides the user the ability to customize sample information collection, report generation and access to sample data and reports.

### EXEMPLARY SYSTEMS OF THE PRESENT INVENTION

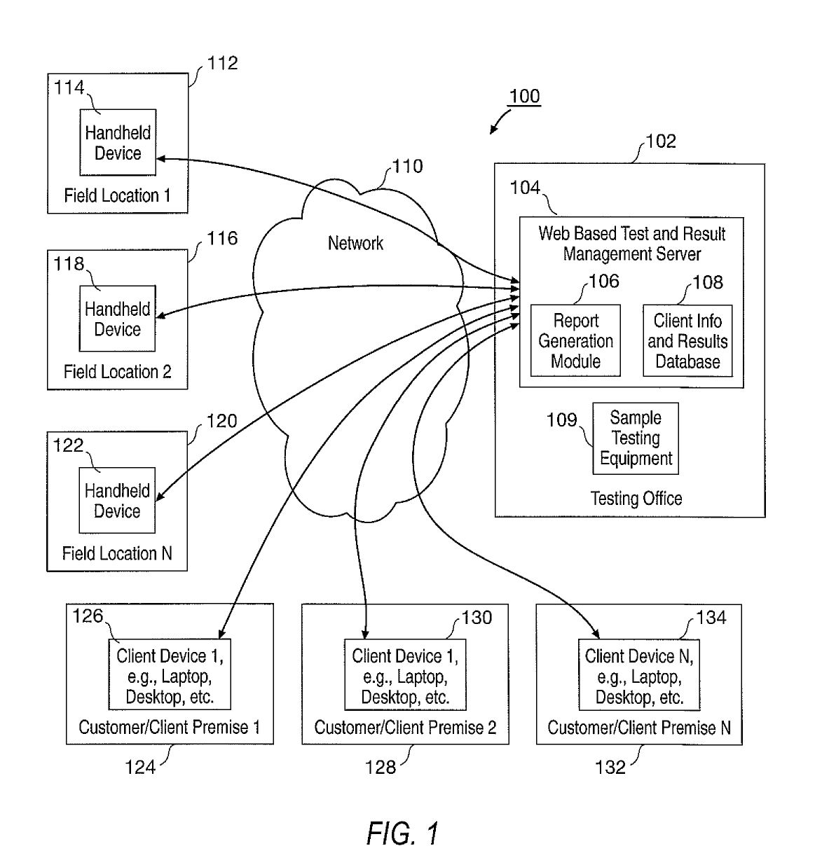

FIG. 1 illustrates a system 100 implemented in accordance with one aspect of the invention. Clients can create and/or define a plurality of geographical field locations e.g., sites, where one or more samples on which tests have to be performed are located. In some embodiments the tests are conducted at the field locations 114, 116, and 120. The field locations 112, 116 and 120 are also referred to as sites. System 100 further includes a testing management office 102 including a web based management sever 104. Various elements of the system communicate, e.g., exchange information, with each other over the network 110 which could be, e.g., Internet or another communications network. In accordance with one aspect of the invention mobile devices 114, 118 and 122 shown in each of the field locations 112, 116 and 120, respectively are capable of taking sample pictures and collecting test data in real time from the field locations/sites, watermarking the sample pictures with relevant information and communicating the watermarked pictures and sometimes other relevant test data/information to the testing office 102 including the web based test management server 104. In some embodiments the mobile devices can communicate the information relevant for sample testing directly to a computer, e.g., wirelessly and/or using a physical connection. In some embodiments the mobile devices 114, 118 and 122 are communications devices such as a smartphone tablet computer the like.

The testing office 102 includes the web based test and result management server 104 and one or more sample testing apparatus 109. Sample testing 109 may also include a measuring tool. The sample testing apparatus 109 include testing equipment for testing various collected samples and other field and audit information. The web based test and result management server 104 includes report generation module 106 for generating and/or compiling reports from the project, field location, audio files, GPS coordinates, document information as well as test data and lab analysis. In some embodiments the test data, lab analysis, sample pictures, forms, reports etc., are received from the mobile devices 114, 118, 122 in the system. In some embodiments some of the information is received from the mobile devices while the actual tests are conducted on a sample at the testing office 102 itself using the sample testing apparatus 109. Server 104 further includes a client information and results database 108. The client information and results database 108 stores information associated with various clients, field locations/sites, projects/jobs corresponding to various clients, and the environmental information and test data/results corresponding to tests which may have been either conducted at the testing office 102 or communicated from one or more mobile devices. Thus, the results database may include information from any or all of the location information, the job information, testing information and test results information, as well as other sources. A validation module (not depicted) may also be included for authentication purposes.

The report generation module 106 uses the above data sources to create job related reports. Photos may be generated with a watermark. The testing office 102 is also referred to as sample processing facility. The database 108 includes information, which is used for watermarking samples at field locations. In some embodiments such information, which is used for watermarking samples includes at least one of job and/or project identification information, or site identification information. In various embodiments this information is communicated from the management server 104 to one or more mobile devices 114, 118, 122.

Customer premises 124, 128 and 130 include client devices 126, 130 and 134 respectively. The client devices 126, 130 and 134 may be, e.g., a laptop, a desktop workstation etc. and can communicate with the management server 104 over the network 110. It is also envisioned that the client device may be any device configured with software to communicate with the management server 104. In accordance with one feature, clients can use the client devices to access, store information and the test result reports prepared in the management server 104, track progress of their projects and/or tests that are being conducted on collected samples at one or more field locations or at the testing office, share project test data with a team member or a group of members. In various embodiments the mobile devices 114, 118, 122 and the client devices 126, 130, 134 include a web browser and can access the internet. In various embodiments data can be managed and updated via the World Wide Web through either a computer or mobile device equipped with internet access.

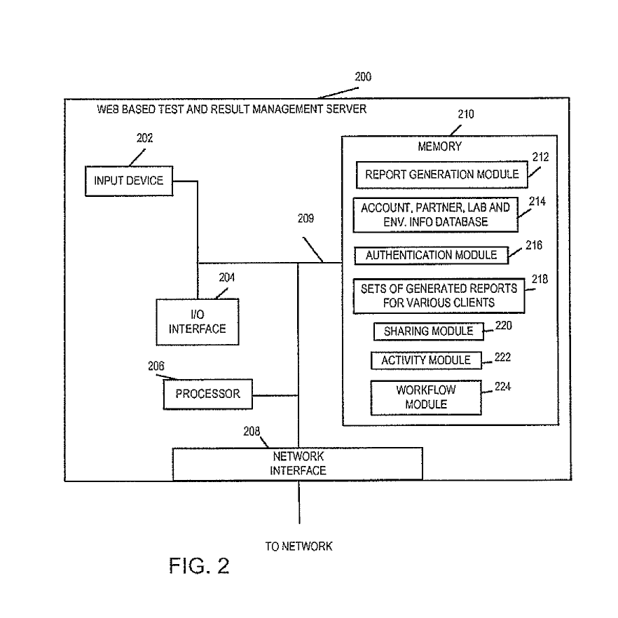

FIG. 2 illustrates an exemplary web based management server 200 implemented in accordance with one exemplary embodiment. The web based management server 200 may be used as the server 104 of the system shown in FIG. 1. Server 200 includes an input device 202, an input/output interface 204, a processor 206, a network interface 208 and memory 210 which are coupled together via bus 209. In some embodiments a display device, such as a monitor, may also be a part of the server 200.

Various elements of the server 200 can exchange data and information over the bus 209. The Input device may be, e.g., a keypad, via which an operator may enter data and/or commands in the server 200. Via the I/O interface 204, the management server 200 can exchange signals and/or information with other devices. The I/O interface supports the receipt and/or transmission of data, information and/or content to/from different servers, devices such as mobile devices 114, 118, 122 and other systems. The processor 206, e.g., a CPU, controls the management server 200 to operate in accordance with the invention. To control the management server 200, the processor 206 uses information and/or routines including instructions stored in memory 210. Management server 200 can connect to different networks via the network interface 208.

It is also envisioned that the management server 200 may take the form of a distributed system (not depicted) wherein two or more physical devices co-operate to provide all the operations of a management server seamlessly, such as in a cloud computing environment.

Memory 210 includes a report generation module 212, account, partner, lab and environmental information database 214, an authentication module 216, sets of generated reports for various clients 218. Although not shown separately the memory 210 also includes routines for controlling the operation of management server 200 in accordance with the invention. The repot generation module 212 and database 214 perform the same or similar function as discussed with, regard to elements 106 and 108 of the management server 104 in FIG. 1. The authentication module 216 is used by the management server 200 to authenticate the clients who wish to access the test reports and/or other information related to their projects. Sets of generated reports 218 include one or more reports generated by the report generation module 212 which can be accessed by the clients to which these reports correspond.

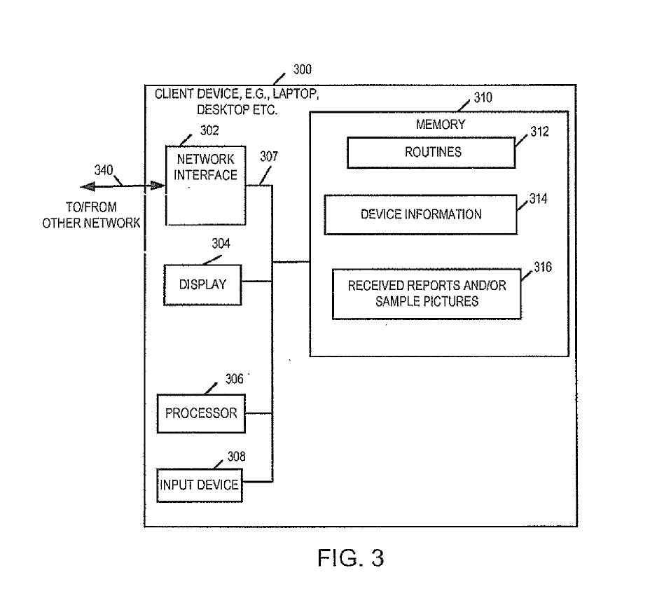

FIG. 3 illustrates an exemplary client device 300 in accordance with one embodiment of the invention. The client device 300 may be used as any of the client devices 126, 130 and 134 shown in FIG. 1. Client device 300 can be a laptop, desktop, or the like, without limitation. The client device 300 includes a network interface 302, a display device 304, e.g. monitor, a processor 306, an input device 308, and memory 310 which are coupled together via bus 307.

Various elements of the client device 300 can exchange data and information over the bus 307. The Input device may be, e.g., a keypad, via which a user/operator may enter data and/or commands in the client device 300. The processor 306, e.g., a CPU, executes routines 312 stored in the memory 310 and, under direction of the routines 312, controls the device 300 to operate in accordance with the invention. The network interface 302 couples the client device 300 to an external network, e.g., the Internet, thereby allowing the client device 300 to receive and send data/information over a network.

Memory 310 includes routines 312, device information 314, and received reports and/or sample pictures 316. Routines 312 are used for controlling the operation of the client device 300. The device information may client device ID. e.g. workstation ID. Media Access Control (MAC) address of the device. etc. and or other information stored in the client device memory 310. In some embodiments the client device 300 uses the device information 314 for getting authentication from the management server 200 to gain access to reports/test data etc. Received reports 316 include one or more reports which have been downloaded and/or received from the management server 200. In some embodiments the received reports include pictures of the sample collected from a site. The sample pictures may be watermarked, e.g. labeled with information relevant to the site, site location, project/job and/or information relevant to a collected sample.

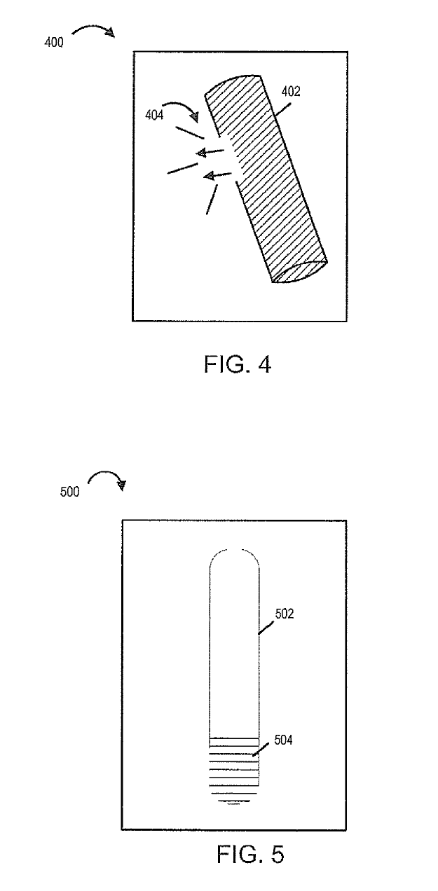

FIG. 4 illustrates a picture 400 of a portion of an exemplary site from which an exemplary sample is collected in accordance with one embodiment of the invention. The picture 400 may, and in some embodiments is taken from a digital camera which may be included in a mobile communications device. The picture 400 includes a portion of the site from which the sample is collected. The exemplary picture 400 shows a broken pipe 402 and the portion 404 of the pipe which is leaking or damaged. In one embodiment a liquid spewing out of the broken pipe 402 from the leaking portion 404 is collected as the sample on which one or more tests are to be performed. e.g. to determine or verify the concentration and composition of the constituents of the liquid sample. In some other embodiments is a solid material, e.g. a paint chip, taken from the damaged area 404.

FIG. 5 illustrates a picture 500 of a container 502 including an exemplary sample collected from a site, in accordance with one embodiment of the invention. The container 502 in some embodiments is. e.g., a vessel, tube etc. for holding a collected sample. In the picture 500, the container 502 is shown to be holding a sample 504 which may be, e.g. in a solid, liquid, semi-solid or gel form.

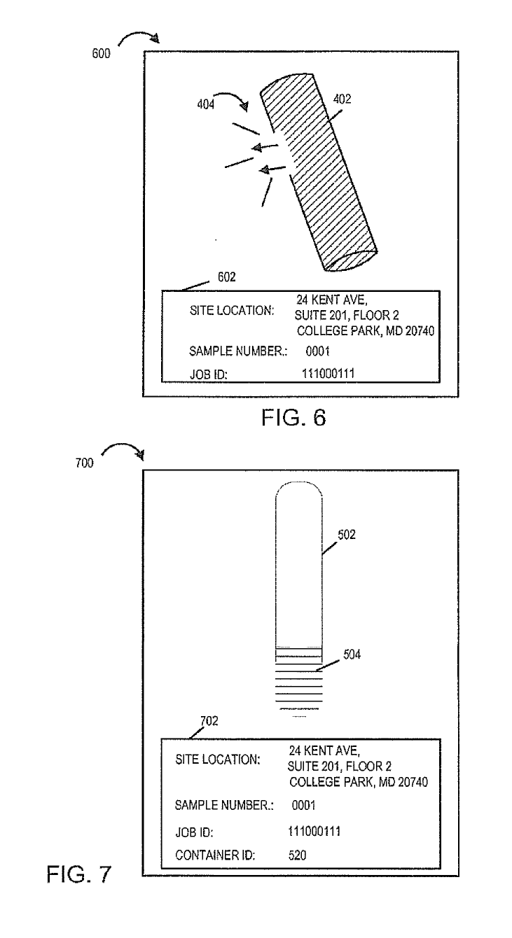

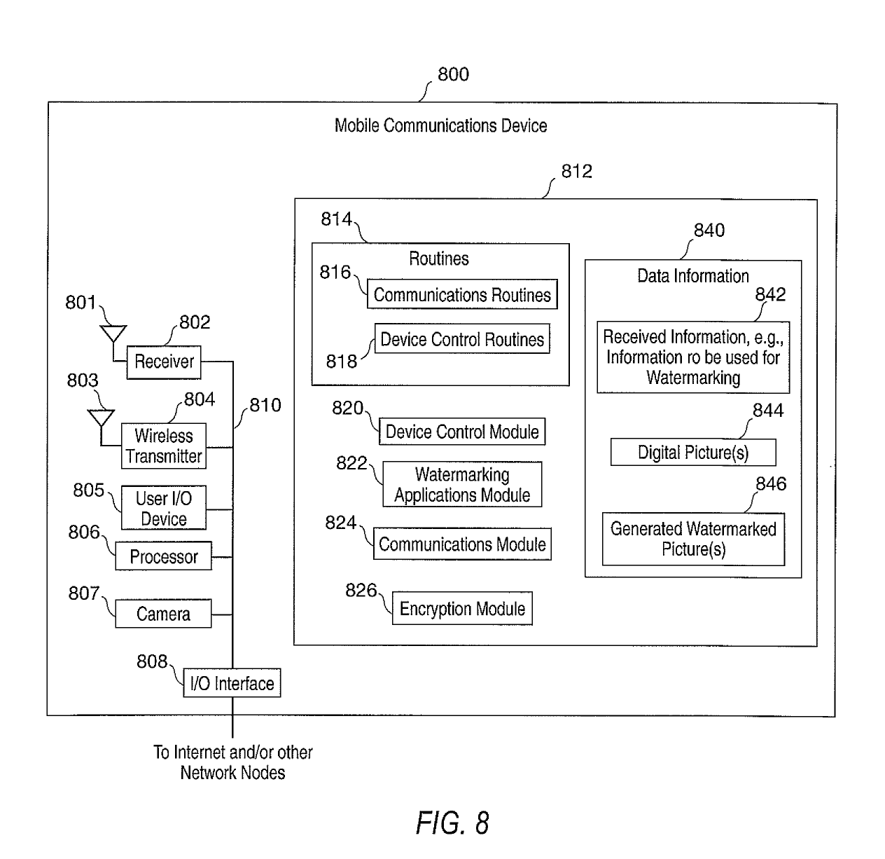

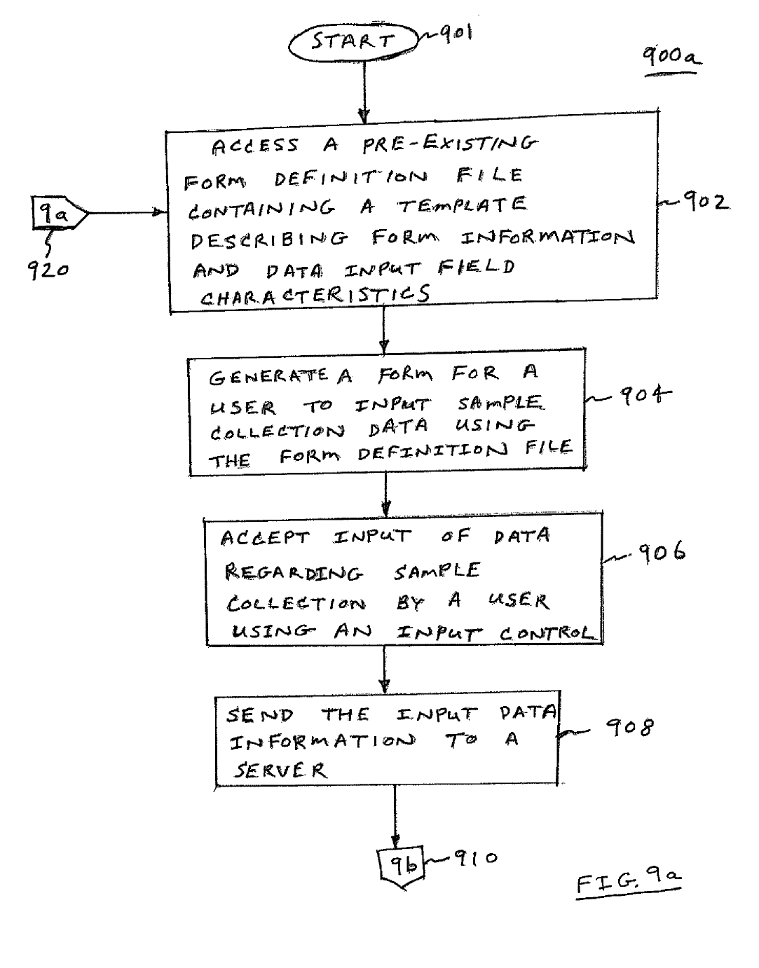

FIG. 6 illustrates a watermarked picture 600 which includes the picture 400 along with information 602. Thus picture 600 can be simply called a watermarked version of the picture 400 discussed above. The watermarked picture 600 is generated in some embodiments by the mobile communications device which has been used for taking the picture 400. FIG. 8 illustrates such an exemplary mobile communication device and will be discussed in detail later. In some embodiments the watermarking is performed by an application on the mobile communications device. In some embodiments the information 602 with which the picture 400 as watermarked is communicated from a sample processing facility such as the testing office 102. The information 602 includes a project and/or job identifier, an address corresponding to the site in the picture, date the picture was taken, and a sample identifier. It should be appreciated that the address used for watermarking the picture includes an office number, complex number, suite number and/or floor number in addition to the street address or the GPS location of the site. In various embodiments the watermarked picture 600 is printed and associated with the corresponding collected sample. In some embodiments associating the picture 600 includes securing said printed watermarked picture 600 to a container used to store the sample.

FIG. 7 illustrates a watermarked picture 700 which includes the picture 500 of the container 502 including the sample 504, along with information 702. Thus picture 700 can be simply called a watermarked version of the picture 500 discussed above. The watermarked picture 700 is generated in some embodiments by the mobile communications device which has been used for taking the picture 500. As discussed above, in some embodiments, watermarking is performed by an application on the mobile communications device. In some embodiments the information 702 with which the picture 500 is watermarked includes some information communicated from the sample processing facility such as the testing office 102 and additional information which is selected by, e.g., an operator handling the sample. For example, the information 702 includes same or similar information discussed with regard to item 602, in addition to that information 702 also includes container identifier which may have been selected by the operator handling the sample and taking watermarking the picture 500. In various embodiments the watermarked picture 700 is printed and associated with the container 502 including sample 504, to which the picture 700 corresponds.

FIG. 8 is a drawing of an exemplary mobile communications device 800, e.g. a smart phone device, in accordance with an exemplary embodiment. The mobile communications device 800 may be used as any one of the mobile devices 114, 118, 122 shown in the system of FIG. 1. In accordance with one aspect of the invention the mobile communications device 800 can be used to take sample pictures and/or to collect test data in real time from the field locations/sites, watermark the sample pictures with relevant information using an application on the mobile device 800 and communicate the watermarked pictures and other relevant test data/information to the web based test management server 104. The mobile communications device 800 can communicate information. e.g., wirelessly and/or using a physical connection, to other device and servers in the system. In some embodiments the mobile communications device 800 is one of a tablet device or a cell phone.

As shown in FIG. 8, exemplary mobile communications device 800 includes a receiver 802, a transmitter 804, user I/O devices 805, a processor 806, a camera 807, I/O interface 808 and memory 812 coupled together via a bus 810 over which the various elements may interchange data and information. The transmitter 804. e.g. a wireless transmitter, transmits information, e.g., collected test data, sample pictures, voice data, and/or other signals. Wireless transmitter 804 is coupled to transmit antenna 803 via which the mobile communications device 80 transmits the various signals to other devices. In some embodiments, the same antenna is used for the receiver and the transmitter. Components of the communications device 800 and their interconnections form an electronic circuit for performing many of the steps of the inventive methods of the invention.

Receiver 802 is responsible for receiving information from other devices. In some embodiments the receiver 802 includes a wireless receiver module and is coupled to a receive antenna 801 via which the mobile communications device 800 receives information from other devices. The received information 842 stored in the memory 812 is received via the receiver 802 from a sample processing facility such as the testing office 102. User I/O devices 805 include, but are not limited to: a microphone, keypad, keyboard, switches, speaker, display, and the like. User I/O devices 805 allow a user of the mobile communications device 300 to input data/information, access output data/information and control at least some functions of the mobile device 800. The camera 807 is capable of capturing images and/or recording videos.

Memory 812 includes routines 814, various modules and data/information 840. The processor 806, e.g., a CPU, executes the routines 814 and one or more modules discussed below and uses the data/information 840 to control the operation of the mobile communications device 800 to implement one or more steps in accordance with the methods of the present invention, as described herein.

Routines 814 include a communications routine 816 and device control routines 818. The communications routine 816 implements the various communications protocols used by the mobile communications device 800. The device control routines 813 are used by the control module 820 to control the operation of various elements of the mobile communications device 800. Modules included in the memory 812 include an application module 822, e.g., a watermarking application, a communications module 824, and an encryption module 826. The application module 822 includes the watermarking application used by the mobile communications device 800 for watermarking one or more picture, e.g., sample picture, site pictures etc., in accordance with the invention. When activated, the application module 822 controls the mobile device 800 to generate pictures watermarked with information corresponding to a project, job, site and/or sample on which testing is to be performed. FIGS. 6 and 7 illustrate examples of watermarked pictures which are generated by the mobile communications device 800 using a watermarking application. Application module 822 also includes software for other applications.

In some embodiments received information 842 received from the testing office 102 is used by the application module 822 for generating the watermarked pictures such as pictures 600 and 700. In some embodiments the application module 822 allows the user of mobile device 800 to enter additional information for watermarking a picture, e.g., using the keypad.

The communications module 824 is used for setting up communications with various other devices and systems. The communications module 824 uses the communications routines 816 which implement the various communications protocols supported by the mobile device 800 to set up communications with other devices and systems. The module 824 is configured to control the transmitter 804 and receiver 802 to transmit and receive information from other devices in accordance with the methods of the invention. For example the communications module 824 controls the transmitter 804 to wirelessly transmit one or more watermarked pictures to the testing office 102.

In an embodiment of the invention, test data is collected and entered into the system via an application process stored on in the application module 822. In addition to providing for the taking and watermarking of photographs and general collection of and uploading of testing data, various forms are provided and made accessible to the user of the mobile device 800. These are described as various methods, below.

The encryption module 826 is used for encrypting watermarked pictures and/or test data corresponding to a collected test sample prior to transmitting the watermarked pictures and/or test data to the testing office 102.

Data/information 840 includes a plurality of stored sets of data/information including received information 842, digital pictures 844, and generated watermarked pictures 846. Received information 842 includes the information to be included in the pictures corresponding to one or more sites and/or samples to be tested and is received from the testing office 102 in some embodiments. As discussed above, the received information 842 includes at least one of job identification information, project identification information, site identification information. e.g., site address, sample identification information. Received information 842 also includes form data such as but not limited to a form definition file. Digital picture(s) include the digital pictures of one or more samples captured by the user using camera 807, such as pictures 400 and 500. The generated watermarked picture(s) 846 are generated by the watermarking application module 822 using the digital pictures) 844 and the information 842 in accordance with the invention as discussed. Examples of generated watermarked pictures are illustrated in FIGS. 6 and 7.

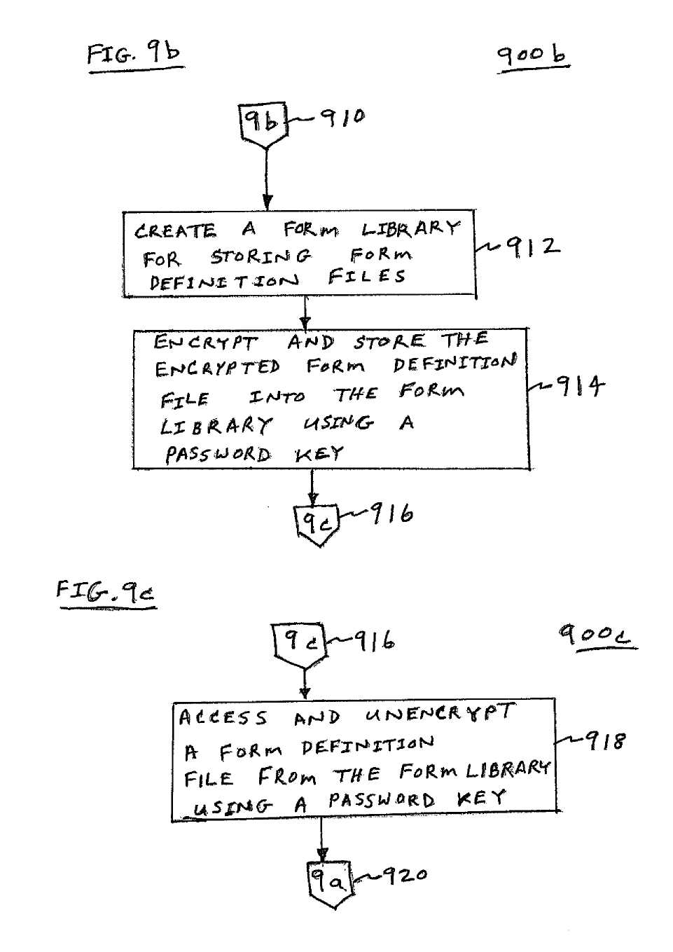

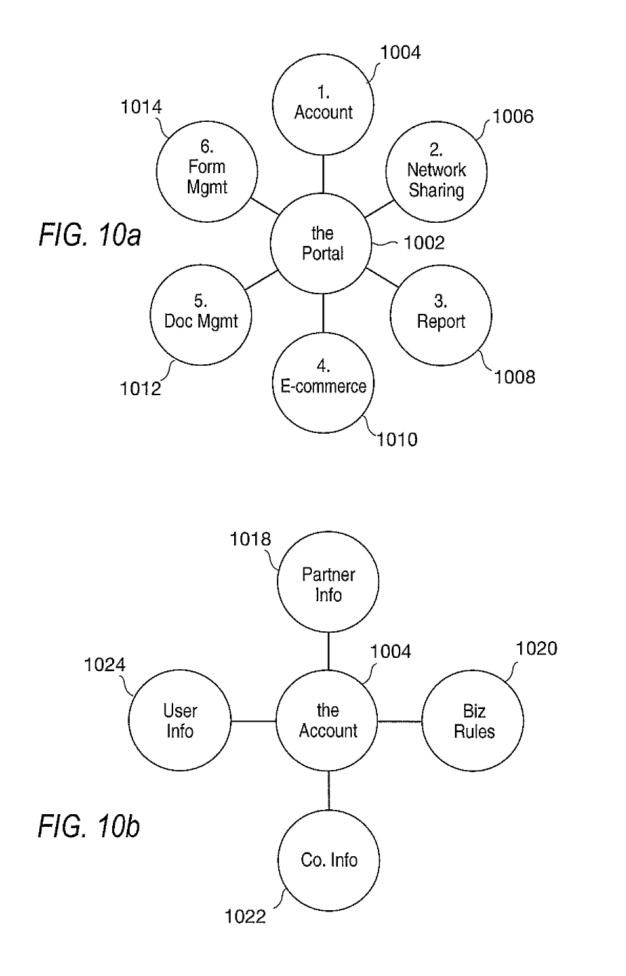

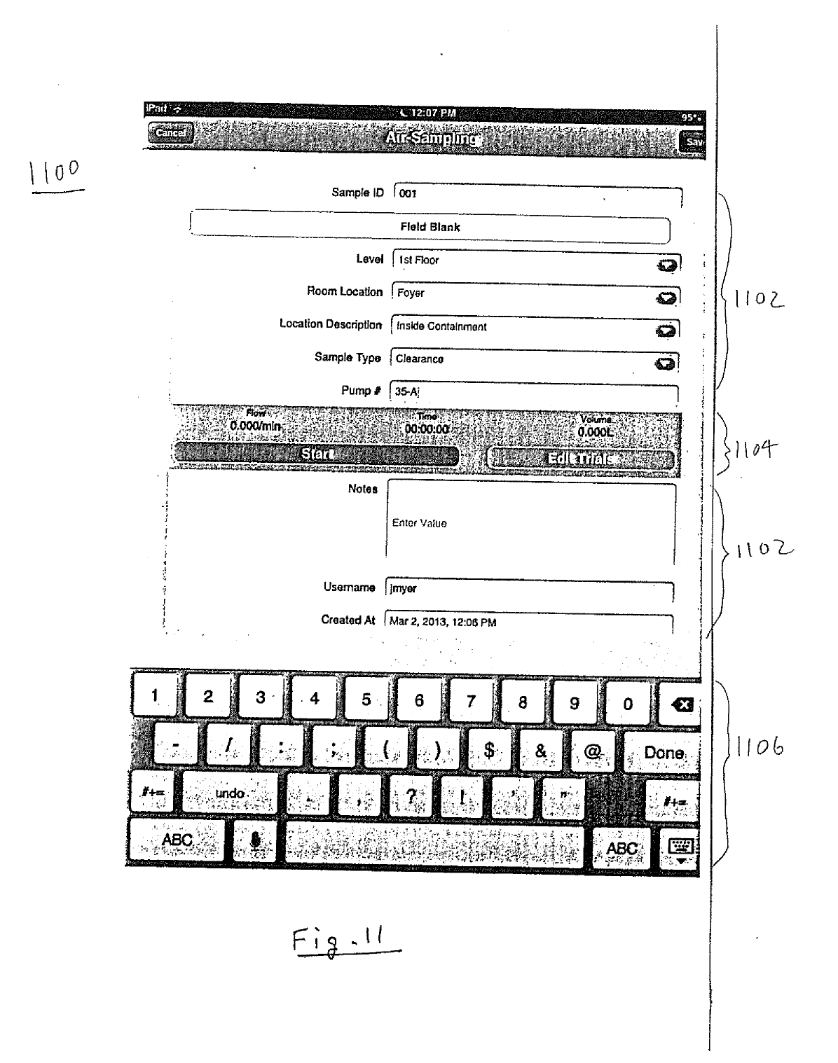

In accordance with a feature of some embodiments, mobile applications which can be used in the mobile communications device 800 are supported and provide users with industry specific applications to collect data from the field e.g. site. In some embodiments, application data is used to create legally defensible document such as an electronic Chain of Custody forms that are used in lieu of paper documents. These are described in the following methods and with reference to FIGS. 9a-10b.

### EXEMPLARY METHODS OF THE PRESENT INVENTION

The techniques of the present invention may be implemented using software hardware and/or a combination of software and hardware. In the case of software, computer executable instructions used to control a processor may be stored in memory or another storage device and then executed by a processor. The present invention is directed to apparatus, e.g. devices such as telephones, servers, and/or other communications system elements which implement all or a portion of the present invention. It is also directed to methods. e.g., method of controlling and/or operating system elements to implement one or more portions of the methods of the invention. The present invention is also directed to machine readable medium, e.g., ROM, RAM, CDs, hard discs, etc., which include machine readable instructions for controlling a machine to implement one or more steps in accordance with the present invention.

In various embodiments devices described herein are implemented using one or more modules to perform the steps corresponding to one or more methods, for example, communicating information corresponding to a field location for testing to a management server, downloading test results to a client device from a server, etc. Thus, in some embodiments various features are implemented using modules. Such modules may be implemented using software, hardware or a combination of software and hardware. Many of the above described methods or method steps can be implemented using computer executable instructions, such as software, included in a computer readable medium such as a memory device, e.g., RAM, floppy disk, etc. to control a machine, e.g., general purpose computer with or without additional hardware, to implement all or portions of the above described methods. e.g. in one or more nodes. Accordingly, among other things, various embodiments are directed to a computer readable medium including computer executable instructions for causing a computer, e.g. processor and associated hardware, to perform one or more of the steps of the above-described method(s). Some embodiments are directed to a device e.g., communications device, including a processor and associated electronic memory configured to implement one, multiple or all of the steps of one or more methods of the invention. Some embodiments describe the processor, associated memory and other components as comprising an electronic circuit which performs the methods.

Some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g. a device or other apparatus described in the present application.

In some embodiments, the processor or processors, e.g., CPUs, of one or more devices. e.g. client device or the web based test and result management server, are configured to perform the steps of the methods described as being as being performed by the device or server. Accordingly, some but not all embodiments are directed to a device with a processor which includes a module corresponding to each of the steps of the various described methods performed by the device in which the processor is included. Each of the modules may be implemented using software and/or hardware.

Numerous additional variations on the methods and apparatus of the various embodiments described above will be apparent to those skilled in the art in view of the above description. Such variations are to be considered within the scope.

The users can download applications to perform a variety of testing services onto a mobile device, including, but not limited to, phones, PDA's, notebooks, tablets, etc. In some embodiments, the users enter data into forms and then electronically transfer information. Data is sent to the web management system, e.g., such as web management server 104, of the present invention where customized tables are presented and available for download, used to create reports or shared to persons or groups of persons, including but not limited to, business partners, laboratories, clients, etc. Some of the features of the applications which are included in the mobile comminations device 800 in some embodiments include:
1. Forms application for creation of customized forms and reports.
2. Create alarms and timers;
3. Utilize automatic calculations such as total area, total volume, etc.;
4. Electronic signature capture;
5. Barcode capture:
6. Tag sample data with specific location information at the site. e.g., room, floor number, text description (which may not be possible to automatically detect) of site and/or OPS location of the site.
7. Create free form sketch;
8. Ability to photograph and watermark photo with sample related information;
9. Ability to record audio and link to job.
10. Ability to record video and link to job; and,
11. Synchronizes job data, pictures, videos, audio recordings with your web-based workspace

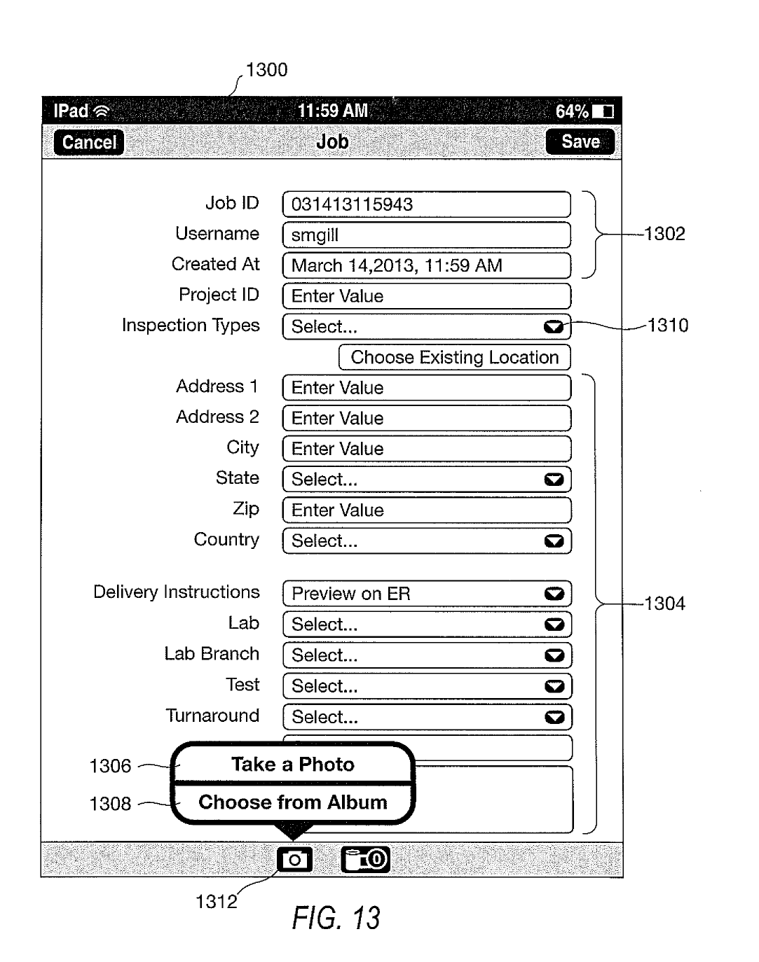

FIG. 13 presents an exemplary user interface screenshot 1300 for input of details regarding a sample collection job. In certain embodiments of the invention, some of the information data fields are pre-populated with job information 1302. Other fields are fix the user to fill in 1304. In some cases, information data fields may be filled in by use of a drop-down selection menu 1310. Also, in instances where a photo may be included, selection of a camera icon 1312 causes the option tabs for taking a photo 1206 or selecting a photo from an album 1308 to appear.

A user interface screenshot depicting an exemplary drop-down list 1500 is provided in FIG. 15. In this example, a user may select a type room 1502 at which a sample is being collected. The user interface also provides for a user to search 1504 for a value, i.e., in this case a type of room, or to edit 1506—add a room type.

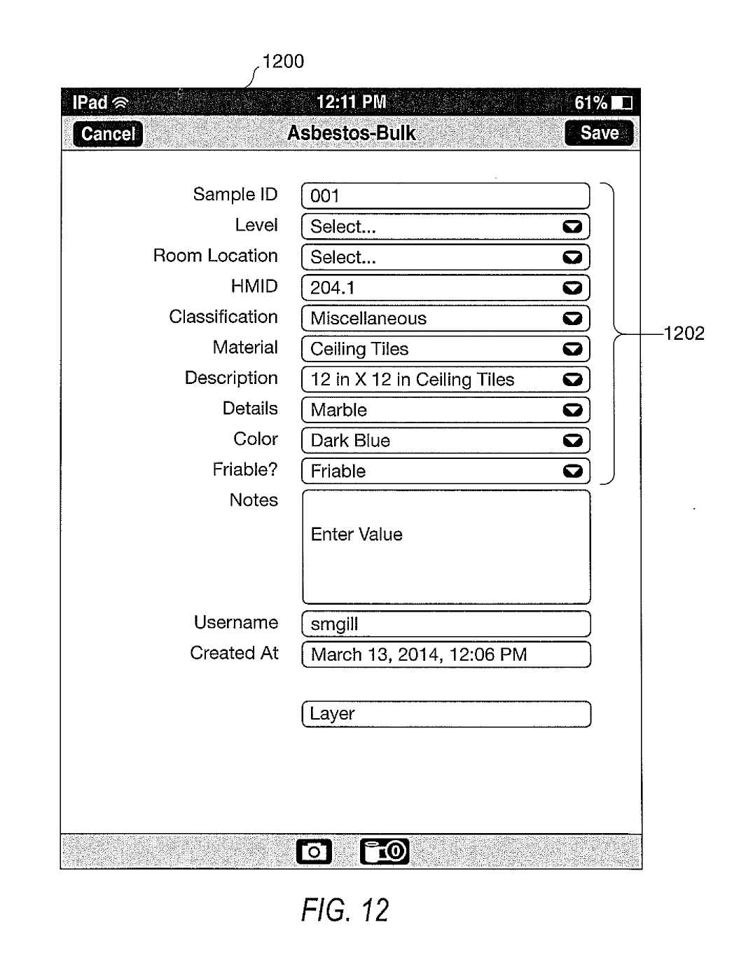

Example user interface screenshots are provided for air sampling 1100 and bulk asbestos 1200 sampling in FIG. 11 and FIG. 12, respectively. In addition to the aforementioned information data fields 1102, 1202, in an embodiment of the invention, a timer 1104 may be provided to capture timing-related information, such as the duration of air sampling in FIG. 1I. Also in certain embodiments, when a user selects a data entry field, a keyboard 1106 appears for input of alphanumeric information.

In an exemplary embodiment of the invention as depicted in FIG. 9a, a sample collection method 900a is provided. This includes accessing 902 a pre-existing form definition file containing a template describing form information and data input characteristics by an electronic circuit of a mobile device. The pre-existing form definition file may have been generated and saved to a form library in a prior sample collection, or may have been particularly designed and customized for use in a given project or type of sample collection. If access controls has been placed on the form definition file, a password or other key, hereinafter referred to generally as a “password key”, may be needed to access the file. Encryption/decryption of files using various types of keys or access codes is well known to those of ordinary skill in the art. An exemplary form definition file follows.

Sample Form Definition File:

```
{
“Report” : {
  “PageOrientation” : “Portrait”,
  “Template” : null
},
“Template” : {
  “Keywards” : {
  “$Overview.AuditTitle”,
  “$Overview.UserName”,
  “$Overview.ConductedOn”,
  “DisplayName”,
  “Sku”
  },
  “Sections” : {
  {
  “Fields” : {
  {
    “Name” : “UserName”,
    “SimplePrompt” : “User Name”,
    “FormFieldType” : “fftUserName”,
    “Phdden” : true
  },
  {
    “SimplePrompt” : “Project ID”,
    “FormFieldType” : “fftText”,
    “Required” : true,
    “Name” : “ProjectId”
  },
  {
    “Name” : “ConductedOn”,
    “SimplePrompt” : “Conducted On”,
    “Required” : true,
    “FormFieldType” : “fftDateTime”,
    “DefanitValue” : “Now”
  },
  {
    “FormFieldType” : “fftTextArea”,
    “Name” : “Personnel”,
    “SimplePrompt” : “Personnel”
  }
  },
  “Name” : “Overview”,
  “DisplayName” : “Overview”
  },
  {
“Fields” : {
  {
    “SimplePrompt” : “Performed By”,
    “FormFieldType” : “fftSignature”,
    “Required” : true,
    “Name” : “PerformedBySignature”
  }
  },
  “Name” : “SignOff”,
  “DisplayName” : “Sign Off”
  }
  },
  “Revision” : “1.0”,
  “Name” : “VA0001”,
  “SurveyName” : “$Overview.AuditTitle”,
  “DisplayName” : “Visual Assessment Form”,
  “Sku” : “VA0001”,
  “ID” : 1
},
  “Survey” : {
  “Version” : 3,
  “Keywords” : “Test, jmyer, 2013-03-11 15:13:05 +0000”,
  “Sections” : {
  {
  “Name” : “Overview”,
  “Records” : {
  {
    “Fields” : {
    {
    “Value” : 31113111305,
    “Name” : “JobID”
    },
    {
    “Value” : “jmyer”,
    “Name” : “UserName”
    },
    {
    “Value” : “1235”,
    Name” : “ProjectId”
    },
    {
    “Value” : “Test”,
    “Name” : “AuditTitle”
    },
    {
    “Name” : “Client”
    },
    {
    “Value” : “2013-03-11 15:13:05 +0000”,
    “Name” : “ConductedOn”
    },
    {
    “Name” : “Personnel”
    }
    }
  }
  }
  },
  {
  “Name” : “SignOff”,
  “Records” : {
  {
    “Fields” : {
    {
    “Value” : {
    “Signature” : “Text”,
    “Photo” :
“39F567EA-E7B8-428C-8086-BC68EEE4367C-9671-
00000653P2CFAC75.jpg”,
    “Date” : “2013-03-11 15:19:50 +0000”
    },
    “Name” : “PerformedBySignature”
    }
    }
  }
  }
  }
  },
  “Guid” : “671966BC-DC71-4347-BE3D-0C9PE3B354D4”,
  “Name” : “Test”
  }
}
```

Next the sample data input form is generated 904 using the form definition file by the electronic circuit, and the form is displayed on a display of the mobile device for a user to input sample collection data. The form includes one or more data input fields. One or more of the form's data input fields may be pre-populated with data based on the form definition file and/or other information available to the mobile device, such as, but not limited to a prior instance of use of the same or similar form for the same or related project, or the like.

There are several usable form structures. In general, forms have one or more sections, each with one or many records, each record having one or many data input fields. Temporary forms are forms which do not have completed data input fields. A “survey” is a completed form ready for uploading to a server and/or saving. A hybrid form is similar to a temporary form except that one or more data input fields are pre-populated.

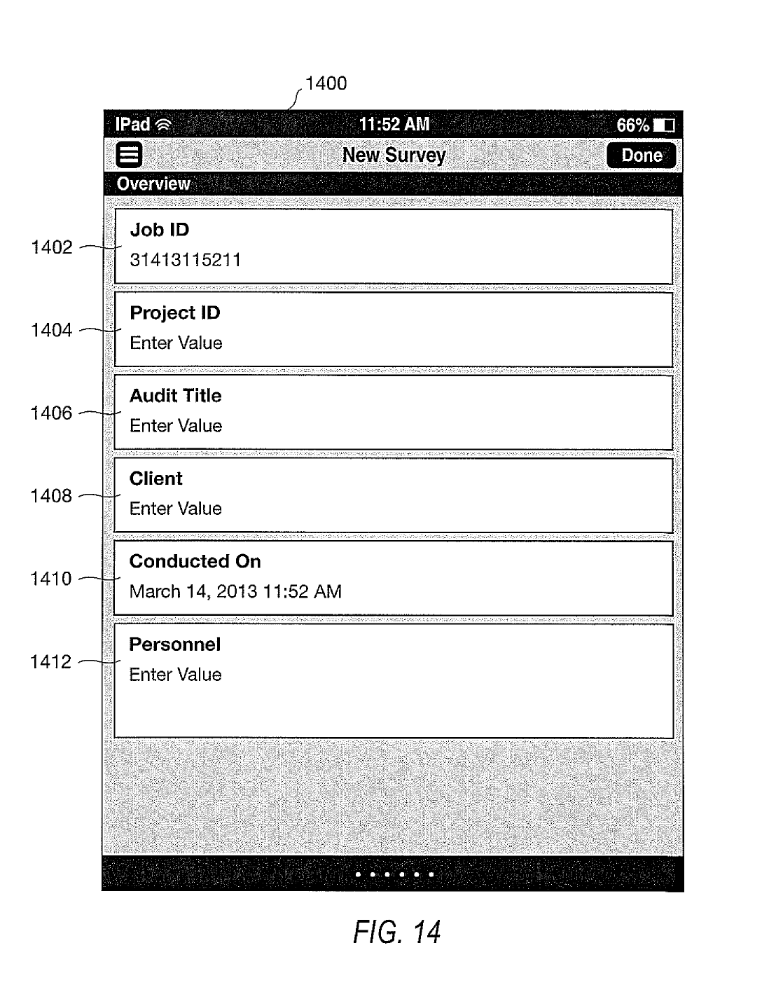

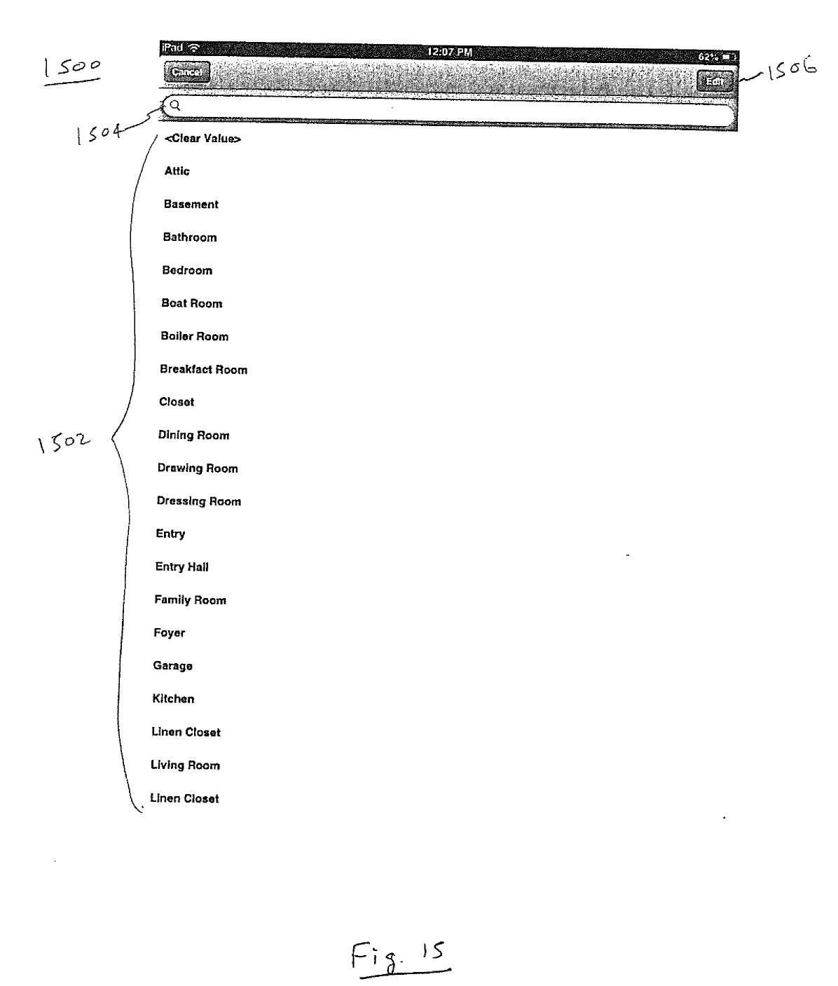

An exemplary form screenshot 1400 for use in inputting new survey information is presented in FIG. 14. Information such as job ID 1402 and date of sample collection 1410 may be pre-populated in the form 1400, with other information data fields, such as project ID 1404, audit title 1406, client 1408, the personnel collecting the samples 1402, and the like, to be input by the user.

Data regarding sample collection is then accepted 906 to the one or more data input fields by the electronic circuit from the user using an input control. For example, a user may use a keyboard of a mobile device to type data into the data input fields. Alternatively or in addition to this, a user may facilitate data input using a pointing device and drop-down menus, or may even input data by imaging, such as with a camera associated with the mobile device.

Some implementations of the invention provide for the capture of field information or data through the use of an auxiliary device associated with the mobile device. One example of this is using a camera to record site or sample information.

Once data has been entered or captured, validation may be performed on the data. This validation may be performed at the field level—i.e., insuring that the input data is sensible as to type, etc.—and/or may be performed against an external standard—compared to potential range and units, etc.

In an embodiment of the invention, the signature of the user is added after the data is validated. This signature may be in electronic form, as is known in the computing arts. In a further embodiment, alter the signature is added, a control field may be inserted into the form to require approval of the information by the user and/or a manager.

Next, the input data information is sent 908 to a server in communication with the mobile device. The step may be performed immediately, or the input form—actually a survey—may be cached for later sending to the server. Alternatively, in some circumstances it may be preferable to require a secure link for saving the collected sample data. It is also envisioned that a form may be rendered into a 3^{rd} party format, such as but not limited to a .pdf format or a Word .doc file.

Also, in some embodiments, data input fields which a user may search can be identified within the form definition file to facilitate generation of search keys for searching one or more form libraries. Thus, a user may perform customized searches for values across predefined fields and one or more forms returned matching the search criteria.

In certain embodiments of the invention, the method continues 920 as illustrated in FIG. 9b. A system and method of managing forms and form definition files in a form library is presented 900b. A form library may be created 912 on the mobile device, or on a server for later access by the mobile device. Form definition files may be stored in a conventional database and protected 914 against unauthorized access, such as by use of encryption using a password key, or the like. This approach lends itself to numerous advantages, such as the ability to allow users to share form definition files based on business partnering arrangements, and to manage larger data sampling projects using different form definition files for various logically or physically related sites or testers. Businesses can programmatically access existing form definition files and use these as the source for automatic form generation. Thus, there can be a one-to-many relationship between form definition files and users, where access 918 to form libraries and form definition files can be managed using password keys or similar access controls, as depicted in FIG. 9c.

Another advantage to this form definition file approach is that a user can save a survey from prior sample collection at a given site or a related site and use the prior survey to generate a new survey having one or more of the data input fields pre-populated with the information front the original form, thereby improving the efficiency of data input.

The inventive systems and methods advantageously provides for numerous user controls. One or more of the following controls are provided in various embodiments: a quick add to list—where the user begins typing and a pick list appears where the user can select an item or add more, lockdown control over one or more data input field—to prevent changing of certain data, hide or display controls, calculation control—which performs an arithmetic evaluation of one or more fields and populates an input field with the results, a signature control—allowing input of a signature to a report, a photo with watermark control—as described hereinbelow, audio controls—to leave a voice record with other input data, and global positioning software (GPS) controls—to allow capture of a tester/user's precise location. It is envisioned that the GPS control will be useful to tie a GPS location to a virtual 2-D or 3D floor plan, which is dependent on GPS location for reference—allowing the use of digital markers on a floor plan to show where a sample was taken or where a hazard occurred.

It is also envisioned that a QR code can be generated embedding certain information about a job and placed where the sample is taken. This QR code may then be used later and scanned to pre-populate data input fields of a form with the prior sampling information.

An exemplary method in accordance with the invention includes collecting a sample from a site, taking a picture of at least a portion of said site front which the sample was collected, and watermarking the picture with at least one of: site related information or project related information to generate a watermarked picture.

In some embodiments watermarking the picture includes incorporating a project or job identifier into the picture. In some embodiments watermarking the picture further includes incorporating an address corresponding to the site into the picture.

In some embodiments taking a picture further includes operating a digital camera to capture a digital image of said portion of the site. In some embodiments the digital camera is part of a mobile communications device, and the watermarking is performed by an application on said mobile communications device, e.g., such as the application 822 discussed above. In some embodiments the mobile communications device is one of a tablet device or a cell phone.

In some embodiments the exemplary method further includes wirelessly transmitting the watermarked picture to a sample processing facility. In some embodiments the exemplary method further includes encrypting the watermarked picture prior to transmitting said watermarked picture to the sample processing facility.

In some embodiments the exemplary method further includes receiving, at the mobile communications device prior to watermarking, information from the sample processing facility to be included in pictures corresponding to the site. In some embodiments the watermarking information includes at least one of job identification information or site identification information.

In some embodiments the exemplary method further includes printing the watermarked picture and associating the printed watermarked picture with the sample. In some embodiments associating the printed watermarked picture with the collected sample includes securing the printed watermarked picture to a container used to store the sample.

In some embodiments the exemplary method further includes storing the watermarked picture on a data storage device in association with test results corresponding to the sample; and making the watermarked picture and test results electronically available to individuals associated with the test site.

Numerous features, embodiments mid apparatus, as well as methods, are implemented in some but not necessarily all embodiments. These include but are not limited to the following:
1. A web-based management system providing an interface for customers to set up projects and assign geographical locations (buildings) to projects where data can be stored, tracked, used to create reports, shared, retrieved, and managed.
2. A mobile device adapted to collect data, e.g. test data, site and/or sample pictures or other data, from the field capable of providing users portable access to industry-specific programs, specifications, instructions and data. For example, in an embodiment there may be specific rules in place for collection of certain samples. e.g. lead, asbestos, etc. The customer can download existing applications or create forms to a mobile device, including but not limited to, phones, palm pilots, notebooks, and the like, to collect data in real time from the field.
3. Field data synchronization and/or delivery are enabled in some embodiments using wireless capabilities resident in mobile personal computing devices. Data can be synchronized with a server over a network using wireless satellite transmission, or directly to a computer workstation using wireless infrared or radio transmission or connected physical connection. In some embodiments two-way communications is provided to facilitate real-time access to remote programs assistance and/or information related to the field assessment being undertaken by using a mobile data management device user.
4. In situations where laboratory analysis is to be conducted, methods mid systems are provided for maintaining a handwritten chain of custody record for the handling of an item transferred to a laboratory and/an electronic chain of custody or both. The electronic form is transferable among the users via the web-based management system. In one example, the data collector uploads data to interface and laboratory retrieves data authenticating the item. The information entered by the data collector is unalterable by the laboratory. After laboratory analysis, the lab uploads final results to a website.
5. Field data can be utilized to create project specific reports through report generation system. Report generator tool integrates predefined stencils or templates with data to produce comprehensive reports.
6. A management system allows users to track progress of their projects by assigning milestones to that project. Once document is added to milestone, then this indicated.
7. The management system allows user to easily share project data with user or group of users. A sharer can assign certain privileges to share.
8. In various embodiments data can be managed and updated via the World Wide Web through either a computer or mobile device equipped with internet access. The report management system of the present invention is an innovative online document management system that provides an interface for you to setup projects where important environmental data can be input, organized, tracked, shared, managed, archived and retrieved.

By facilitating real-time communication through a network, the present invention allows true collaboration between entities collecting the field samples, the lab testing samples, the entity or entities generating and receiving reports, as well as their business & lab partners and associates. Every project, location, document, and user is securely stored and organized for easy, fast retrieval.

In an embodiment of the invention, reports, contracts, specifications, bid documents, laboratory data, licensing & credentials, project submittals, and waste manifests can be managed online using a document management file. All the data related to a project can be stored in one place, where information can be searched and managed without having to search through multiple files, folders, computers or networks. Milestones or place holders can be created for each document or task to be saved or performed. Once tasks are completed or files are finalized and uploaded, a status indicator is updated. Individuals who are entitled may then access documents and files from anywhere, and can determine information such as the project percentage completion easily.

FIG. 10a illustrates an exemplary logical organization of a website portal 1000 for managing an account and/or form library. In an embodiment of de invention, the portal 1002—i.e., a company user's web portal—includes the company's account module 1004, network sharing rights module 1006, reports module 1008, e-commerce module 1010, document management module 1012 and form management module 1014. The form management module also includes several components (not depicted) including a form builder, form library and a form audit module.

FIG. 10b further illustrates various components of the account module 1004. These include partnering information 1016, business rules 1020, company information 1022 and user information 1024. Business rules 1020 include regarding such things as user rights for altering information, and the like.

The report management system of the present invention provides a professional network service for registered users to create a connection between themselves and their business partners. The purpose of this feature is to allow users to maintain a list of people they know and trust in business. i.e., “business partners”. Users may invite anyone—whether an existing site user or not—to become a business partner. This list of business partners can then be used in a number of ways.

For example, in an embodiment of the invention, a contact network is created by inviting a trusted contact—client, contractor, laboratory, subcontractor, etc.—to become your business partner or by having another registered user invite you to become their business partner. In either case, an email will be sent to the invited person requesting them to link. That user will have the option to accept or reject this offer

Business partners can then be used to share projects, consisting of multiple locutions & documents, locations, consisting of multiple projects & documents, or documents only. Business partners can share projects, reports, and forms internally and/or publish them to the public. Registered users can also assign tasks and deadlines to their business partners using a task bulletin.

Users can share any of your projects, locations and/or documents internally or with your Business Partners, Groups, or Users. Permissions allow you the ability to manage the rights and privileges of other users to view your information. For example, a User may want to share a project document (such as an Environmental Report) with another Business Partner, but may not want them to view other sensitive documents for that project.

In an embodiment of the invention, a user interface makes it easy to quickly invite another to view project related documents for such reasons as bidding opportunities, compliance audits, etc. without compromising others to see unrelated confidential materials. When a user invites another business partner to view their project an email notification is sent to that user announcing that a project is available for them to view. This allows for quick and safe sharing of documents, and potentially saves costs for printing, couriers, ravel, and the like.

As described herein, various embodiments of the present invention support mobile applications, which provide registered users with industry-specific applications for collecting data from the field. For example, in an environmental field sampling use, users download existing applications to a mobile device, including, but not limited to, phones, PDA's, notebooks, etc. to perform a variety of environmental services. The system presents a form developed specifically for field data entry. This approach has been shown to increase worker productivity and consistency with many years of field-testing. It is quick, efficient and user-friendly and increases data consistency and accuracy through the use of industry standard dropdown and pick lists. Registered users are able to electronically transfer data files to the report management system, where customized tables are presented and available for download as excel reports.

The report management system of the present invention provides registered users a process to setup projects where environment laboratory data can be collected, stored, tracked, shared, retrieved, and managed.

In situations where laboratory analysis is required, an electronic chain of custody form can be created utilizing our mobile application, which is then transferable to one of our authorized laboratories. The data collector just uploads the data to the report management system of the present invention, activates the file and the instantly the laboratory will receive it allowing them to log in the order before the samples arrive. The information entered by the data collector is unalterable by the laboratory. After laboratory analysis is completed, the lab will upload your results to the website and you can review then in a customized table provided by the report management system of the present invention. This helps to improve data consistency, increase productivity, ensure quality control & quality assurance and save time.

Building a database management system is expensive and time consuming. With no up-front expenses, long-term commitments, staffing, or software the report management system of an embodiment of the present invention is a cost-effective way to manage environmental data.

An embodiment of the present invention also provides a report management system that delivers a number of benefits for users, including, but not limited to: cost-effectiveness and security—multiple layers of operational and physical security to ensure the integrity and safety of data.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A sample collection method comprising:
generating, by an electronic circuit of a mobile device, a form for displaying on a display of the mobile device for a user to input sample collection data, the form comprising one or more data input fields;
accepting, by the electronic circuit, input of data regarding sample collection to the one or more data input fields by a user from an input control of the mobile device;
sending, by the electronic circuit, input data information to a server in communication with the mobile device.

2. The sample collection method according to claim 1, wherein the accepting input of data further comprises capturing field information by the electronic circuit using an auxiliary device associated with the mobile device.

3. The sample collection method according to claim 2, wherein the auxiliary device is a camera.

4. The sample collection method according to claim 1, wherein the generating of a form further comprises
accessing by the electronic circuit, a pre-existing form definition file containing a template describing the information to be displayed on the form and characteristics of one or more data input field of the form; and,
displaying, by the electronic circuit onto the display, a form consistent with the form definition file.

5. The sample collection method according to claim 4, wherein the displaying of the form further comprises pre-populating known data into one or more data input field of the form.

6. The sample collection method according to claim 4, wherein the generating of a form further comprises:
accepting, by the electronic circuit, input by a user from an input control of the mobile device, the input regarding customization of the form; and,
updating the form in accordance with the user input.

7. The sample collection method according to claim 2, wherein a validation as performed at the field level.

8. The sample collection method according to claim 2, wherein field validation is performed against an external standard.

9. A method of managing data input forms on a mobile device, the method comprising:
creating, by an electronic circuit of the mobile device, a form library; and
saving, by the electronic circuit, form information in one or more form definition files in the form library.

10. The method of managing data input loons on a mobile device according to claim 9, further comprising:
providing, by the electronic circuit, one or more access level for one or more form definition file, each of the one or more access levels having an associated password key; and,
encrypting and saving by the electronic circuit, each of the one or more form definition files using its associated password key.

11. The method of managing data input forms on a mobile device according to claim 9, further comprising:
accessing and unencrypting, by the electronic circuit, an encrypted form definition file using its associated password key.

12. The sample collection method according to claim 1, further comprising
generating, by the electronic circuit, a Quick response (QR) bar code comprising site information and input data information; and,
tagging a physical location with the QR code.

13. The sample collection method according to claim 1, wherein the generation of the form further comprises:
reading, by the electronic circuit, a previously placed QR code at a physical location; and,
displaying of the form further comprises pre-populating information read from the QR code into one or more data input field of the form.

14. A sample collection system comprising:
a mobile device comprising a processor and associated electronic memory in operative commination with a display and an input control, the processor and associated electronic memory configured to perform the steps of:
generating a form for displaying on the display of the mobile device for a user to input sample collection data, the form comprising one or more data input fields,
accepting input of data regarding sample collection to the one or more data input fields by a user from an input control of the mobile device;
sending input data information to a server in communication with the mobile device.

15. The sample collection system according to claim 14, wherein the accepting input of data further comprises capturing field information using an auxiliary device associated with the mobile device.

16. The sample collection system according to claim 15, wherein the auxiliary device is a camera.

17. The sample collection system according to claim 14, wherein the generating of a form further comprises
accessing a pre-existing form definition file containing a template describing the information to be displayed on the form and characteristics of one or more data input field of the form; and,
displaying onto the display, a form consistent with the form definition file.

18. The sample collection system according to claim 17, wherein the displaying of the form further comprises pre-populating known data into one or more data input field of the form.

19. The sample collection system according to claim 15, wherein a validation is performed at the field level.

20. The sample collection system according to claim 15, wherein field validation is performed against an eternal standard.

21. The sample collection system according to claim 14, wherein the processor and associated computer memory are further configured to perform the steps of:
generating a Quick response (QR) bar code comprising site information and input data information; and,
tagging a physical location with the QR code.

22. The sample collection method according to claim 14, wherein the processor and associated computer memory are further configured to perform the steps of:
reading a previously placed QR code at a physical location; and,
displaying of the form further comprises pre-populating information read from the QR code into one or more data input field of the form.

23. A system of managing data input forms on a mobile device, the system comprising:
a processor and associated electronic memory configured to perform the steps of:
creating a form library; and,
saving form information in one or more form definition files in the form library.

24. The system of managing data input forms on a mobile device according to claim 23, wherein the processor and associated electronic memory are further configured to perform the additional steps of:
providing one or more access level for one or more form definition file, each of the one or more access levels having an associated password key; and,
encrypting and saving each of the one or more form definition files using its associated password key.

24. The system of managing data input forms on a mobile device according to claim 23, wherein the processor and associated electronic memory are further configured to perform the additional steps of:
accessing and unencrypting, by the electronic circuit, an encrypted form definition file using its associated password key.

25. A report generation method comprising:
selecting a report format for sample collection data by a user;
modifying the report format by the user; and,
generating, by a processor of a server, a report for presentation of sample collection data, the report comprising one or more data fields arranged in accordance with the user modified report format.

26. The method according to claim 25, further comprising translating, by the processor, the report into a third party format.

27. The method according to claim 26, wherein the third party format is selected from the group consisting of, but not limited to: a Microsoft™ Word™ document and an Adobe™ portable document format (pdf) file.

28. The sample collection method according to claim 1, further comprising:
accepting, by the electronic circuit, input of signature by a user of the mobile device; and;
sending, by the electronic circuit, the signature to a server in communication with the mobile device.

29. The sample collection method according to claim 28, further comprising:
modifying the form to require one or more signatures.
